(19) United States
(12) Patent Application Publication
(10) Pub. No.: US 2006/0227757 A1
(43) Pub. Date: Oct. 12, 2006

(54) Electronic device and radio communication terminal

(75) Inventor: Hiromitsu Mizukami, Suwa-shi (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/388,064

(22) Filed: Mar. 23, 2006

(30) Foreign Application Priority Data
Mar. 25, 2005 (JP) 2005-087910

(51) Int. Cl. H04J 3/06

(52) U.S. Cl. 370/350

(57) ABSTRACT

An electronic device includes a plurality of radio transmitting units, at least one radio receiving unit, and a wire communication member, the plurality of radio transmitting units and the radio receiving unit carry out radio communication with one another in the device, and the wire communication member communicates a synchronization signal among the plurality of radio transmitting units and the radio receiving unit by wire.

### BACKGROUND

1. Technical Field

The present invention relates to an electronic device and a radio communication terminal, and is preferably applied to a terminal having at least two parts in close proximity such as a clamshell type mobile phone handset in which data is transmitted between these parts.

2. Related Art

In recent years, in the field of mobile phone handsets, liquid crystal displays mounted in mobile phone handsets have had higher resolution so that still images such as characters and graphics as well as still images and moving images taken by a digital camera can be displayed with higher definition. The quantity of data exchanged between a digital camera and such a liquid crystal display increases accordingly, and the use of a high speed transfer method called LVDS (Low Voltage Differential Signaling) has been proposed for connection with displays and imaging devices.

Also in recently developed mobile phone handsets, the clamshell design that allows the telephone handset to be folded has been employed, so that the handset can have a larger display size and any of operation buttons can be prevented from being inadvertently pressed while the user carries the handset with her/him. In the clamshell design, a first case part includes a control unit that mainly controls the external radio communication function of the mobile phone and a second case part includes a display. The first and second case parts are hinged together to open and close.

Meanwhile, the resolution of a display to be mounted in a mobile phone handset has increased, and if image data at a high bit rate is transferred by wire to the display, a flexible printed circuit board to send the signal to the display needs a large number of pins. Therefore, if data is transferred between the first case part and the second case part by wire, the flexible printed circuit board with an increased number of pins must be passed through the hinge, which complicates the hinge structure or its mounting step. There has been a proposed method of transmitting data between the first and second case parts by internal radio communication using an internal radio communication antenna provided for each of the first and second case parts instead of using the flexible printed circuit board.

According to a method disclosed by JP-A-2002-171321, a mobile radio terminal including a radio device and an operation device separable from each other is provided in order to carry out radio communication with a base station, and when these devices are combined, they are electrically connected by connectors provided in these devices for transferring/receiving audio data or image data, while when the devices are separated, audio data or image data is transmitted/received between these devices by Bluetooth® wireless communication (see page 1, FIG. 1).

For example, Japanese Patent No. 3165724 discloses a two-way communication device supplied with power from a power source line to carry out communication in one way by wireless and communication in the other way by the power source line (see page 1, FIG. 1).

In these examples disclosed by JP-A-2002-171321 and Japanese Patent No. 3165724, wire and wireless techniques are combined, but when these methods are applied to a device having a plurality of radio transmitting units and one or more radio receiving units, a plurality of wireless channels are necessary, and it is highly possible that these plurality of channels interfere with one another. Therefore, a plurality of kinds of radio communication cannot be carried out efficiently.

### SUMMARY

In order to solve the above described disadvantages, available time or frequencies may be used by monitoring the state of frequency use by carrier sense, so that interference may be avoided, in other words, CSMA/CD (Carrier Sense Multiple Access with Collision Detection) may be employed. However, the use of the measure such as CSMA gives rise to a reduction in the transmission efficiency, which is not preferable when high bit rate image data is transmitted to the display.

An advantage of some aspects of the invention is to provide an electronic device and a radio communication terminal that allow multiple kinds of radio communication to be carried out efficiently in the electronic device while keeping interference in a low level.

An electronic device according to a first aspect of the invention includes a plurality of radio transmitting units, at least one radio receiving unit, and a wire communication member, the plurality of radio transmitting units and the radio receiving unit carry out radio communication with one another in the device, and the wire communication member communicates a synchronization signal among the plurality of radio transmitting units and the radio receiving unit by wire.

According to the first aspect, a synchronization signal is communicated by wire using the wire communication member, so that multiple kinds of radio communication can efficiently be carried out between the plurality of radio transmitting units and the one or more radio receiving units while keeping interference in a low level.

According to a second aspect of the invention, in the electronic device according to the first aspect, the plurality of radio transmitting units and the radio receiving unit carry out radio communication by code division multiple access, and a spreading clock signal and a symbol synchronization signal generated by a synchronization signal generator provided in one of the radio transmitting units and the radio receiving unit are communicated by wire to the rest of the radio transmitting units and/or the radio receiving unit using the wired communication unit.

According to the second aspect, when radio communication is carried out between the plurality of radio transmitting units and the one radio receiving unit by code division multiple access (CDMA), a spreading clock signal and a symbol synchronization signal generated in a synchronization signal generator provided in one of the radio transmitting units and the radio receiving unit are communicated by wire to the rest of the radio transmitting units and/or the radio receiving unit using the wire communication member. Therefore, the timing and phase of the spreading codes can be synchronized among the plurality of radio transmitting units and the radio receiving unit, so that radio communication can be carried out by code multiplexing without interference in a common band while keeping the code orthogonality according to code division multiple access.

According to a third aspect of the invention, in the electronic device according to the first aspect, the plurality of radio transmitting units and the radio receiving unit carry out radio communication by orthogonal frequency division multiplexing, and a symbol synchronization signal generated by a synchronization signal generator and a carrier synchronization signal oscillated by a local oscillator provided in one of the radio transmitting units and the radio receiving unit are communicated by wire to the rest of the radio transmitting units and/or the radio receiving unit using the wire communication member.

According to the third aspect, when radio communication is carried out between the plurality of radio transmitting units and the one radio receiving unit by orthogonal frequency division multiplexing (OFDM), a symbol synchronization signal and a carrier synchronization signal oscillated by one of the radio transmitting units and the radio receiving unit are transmitted by wire to the rest of the radio transmitting units and/or the radio receiving unit using the wire communication member. In this way, the carrier frequency offset between the radio transmitting units can be eliminated, and the orthogonality of an OFDM signal received at the radio receiving unit can be secured. In addition, since there is no frequency offset at the radio receiving unit, the orthogonality of the demodulated signal can be secured, the symbol synchronization signal allows the symbol interval to be synchronized among all the radio transmitting units and the radio receiving unit, and the transmission timings can be synchronized.

According to a fourth aspect of the invention, in the electronic device according to the first aspect, radio communication is carried out between the plurality of radio transmitting units and the radio receiving unit by time division multiple access, and a synchronization signal generated by a transmission timing control unit provided in one of the radio transmitting units and the radio receiving unit is communicated by wire to the rest of the radio transmitting units and/or the radio receiving unit using the wire communication member.

According to the fourth aspect, radio communication is carried out between the plurality of radio transmitting units and the radio receiving unit by time division multiple access (TDMA), and the synchronization signal at the time is transmitted using the wire communication member. Therefore, the plurality of radio transmitting units can transmit while the radio transmitting units are allowed to be synchronized in response to the transmission timing synchronization signal from the radio receiving unit. The transmission timing at the time is controlled by the transmission timing synchronization signal from the one radio receiving unit, and therefore multiplex communication can readily be carried out by TDMA while signals do not overlap among a plurality of transmitters.

A radio communication terminal according to a fifth aspect of the invention includes a first case part, a second case part coupled to the first case part, and a coupling member that couples the first and second case parts in such a manner that the positional relation between the first and second case parts can be changed, one of the first and second case parts has a plurality of radio transmitting units, and the other has at least one radio receiving unit. A wire communication member that communicates a synchronization signal between the plurality of radio transmitting units and the radio receiving unit is provided.

According to the fifth aspect, when radio communication is carried out between the plurality of radio transmitting units and the one or more radio receiving units between the first and second case parts coupled by the coupling member, the synchronization signal is communicated by wire, so that multiple kinds of radio communication can efficiently be carried out between the plurality of radio transmitting units and the one or more radio receiving units while keeping interference in a low level.

According to a sixth aspect of the invention, in the radio communication terminal according to the fifth aspect, the plurality of radio transmitting units and the radio receiving unit carry out radio communication by code division multiple access, and a spreading clock signal and a symbol synchronization signal generated by a synchronization signal generator provided in one of the radio transmitting units and the radio receiving unit are transmitted by wire to the rest of the radio transmitting units and/or the radio receiving unit using the wired communication unit.

According to the sixth aspect, in the radio communication terminal, the same advantages as those brought about by the second aspect described above can be provided.

According to a seventh aspect of the invention, in the radio communication terminal according to the fifth aspect, the plurality of radio transmitting units and the radio receiving unit carry out radio communication by orthogonal frequency division multiplexing, and a symbol synchronization signal generated by a synchronization signal generator and a carrier synchronization signal oscillated by a local oscillator provided in one of the radio transmitting units and the radio receiving unit are communicated by wire to the rest of the radio transmitting units and/or the radio receiving unit using the wire communication member.

According to the seventh aspect, in the radio communication terminal, the advantages the same as those brought about by the third aspect can be provided.

According to an eighth aspect of the invention, in the radio communication terminal according to the fifth aspect, the plurality of radio transmitting units and the radio receiving unit carry out radio communication by time division multiple access, and a synchronization signal generated by a transmission timing control unit provided in one of the radio transmitting units and the radio receiving unit is communicated by wire to the rest of the radio transmitting units and/or the radio receiving unit using the wired communication unit.

According to the eighth aspect, in the radio communication terminal, the advantages the same as those brought about by the fourth aspect described above can be provided.

### BRIEF DESCRIPTION OF THE DRAWINGS

The invention will be described with reference to the accompanying drawings, where like numbers reference like elements.

FIG. 1 is a perspective view of a clamshell type mobile phone handset according to one embodiment of the invention in an opened state.

FIG. 2 is a perspective view of the clamshell type mobile phone handset in FIG. 1 in a closed state.

FIG. 3 is a block diagram of a data transmitting device between first and second case parts according to a first embodiment of the invention.

FIG. 4 is a block diagram of an example of a radio communication unit that can be applied to the first embodiment.

FIG. 5 is a block diagram of an example of a radio receiving unit that can be applied to the first embodiment.

FIG. 6 is a block diagram of another example of a data transmitting device between the first and second case parts according to the first embodiment.

FIG. 7 is a block diagram of a radio receiving unit that can be applied to the first embodiment.

FIG. 8 is a block diagram of a radio transmitting unit that can be applied to a second embodiment of the invention.

FIG. 9 is a block diagram of a radio receiving unit that can be applied to the second embodiment.

FIG. 10 is a block diagram of another example of the radio receiving unit that can be applied to the second embodiment.

FIG. 11 is a block diagram of a radio transmitting unit that can be applied to a third embodiment of the invention.

FIG. 12 is a block diagram of a raid receiving unit that can be applied to a third embodiment of the invention.

FIG. 13 is a general overview of a rotary type mobile phone handset as another example of a mobile phone handset to which the invention can be applied.

### DESCRIPTION OF EXEMPLARY EMBODIMENTS

Now, a mobile phone handset according to an embodiment of the invention will be described in conjunction with the accompanying drawings.

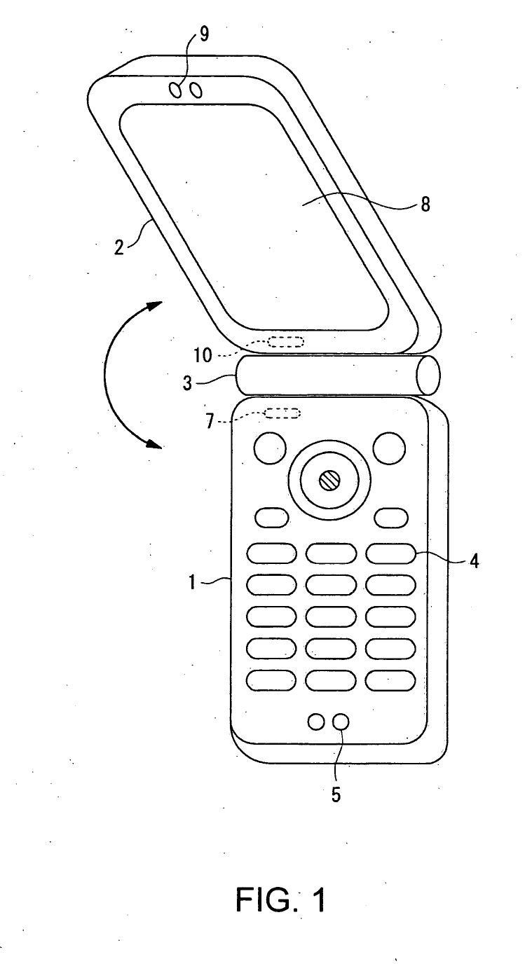

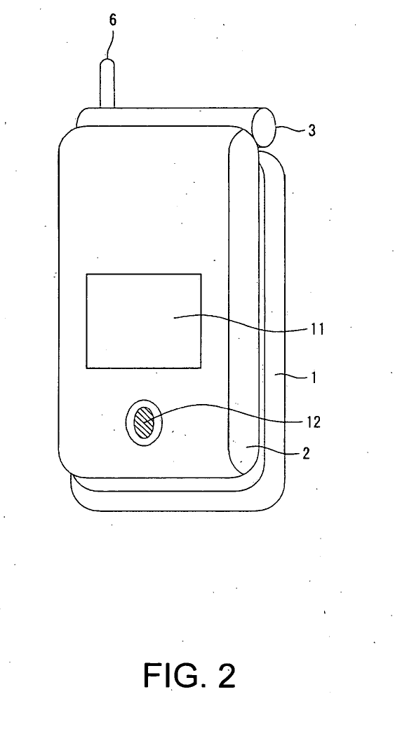

FIG. 1 is a perspective view of a clamshell type mobile phone handset in an open state, and FIG. 2 is a perspective view of the clamshell type mobile phone handset in a closed state.

In FIGS. 1 and 2, operation buttons 4 are provided at the surface of a first case part 1, a microphone 5 is provided at the lower end of the case part 1, and an external radio communication antenna 6 is attached to the upper end of the first case part 1. A display 8 is provided at the surface of a second case part 2, and a speaker 9 is provided at the upper end of the second case part 2.

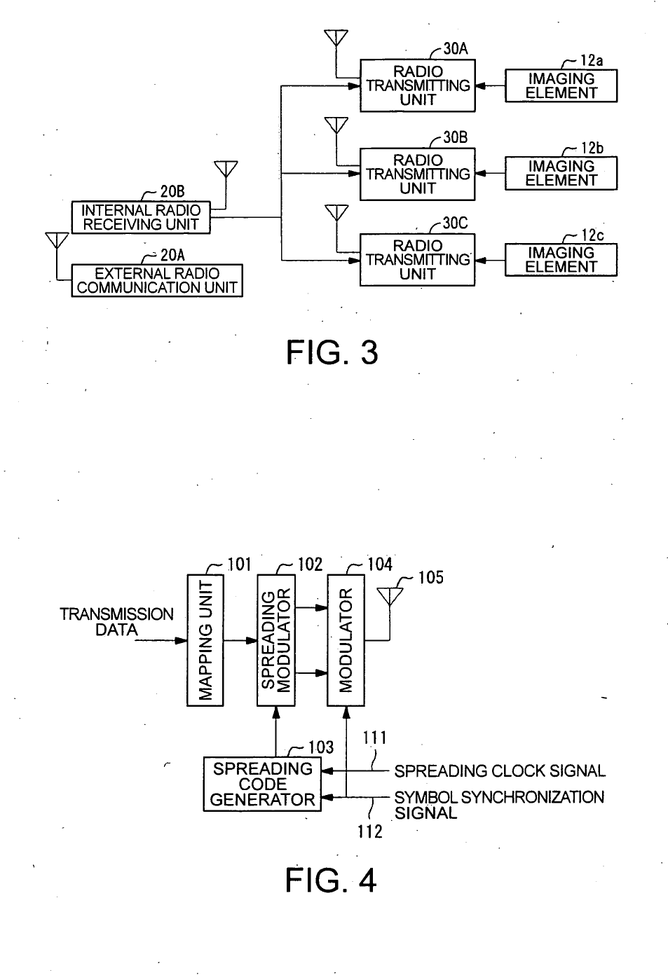

As shown in FIG. 2, a display 11 and an imaging device 12 having imaging elements 12a to 12c as shown in FIG. 3 are provided at the back surface of the second case part 2. For example, as the displays 8 and 11, a liquid crystal display panel, an organic EL panel, or a plasma display panel can be used. The imaging elements 12a to 12c may be CCD or CMOS sensors. The first and second case parts 1 and 2 are provided with internal radio communication antennas 7 and 10 for internal radio communication between the first and second case parts 1 and 2.

The first and second case parts 1 and 2 are coupled through a hinge 3, and the second case part 2 is pivoted around the hinge 3, so that the second case part 2 can be closed down to the first case part 1. The second case part 2 is closed down to the first case part 1, so that the operation buttons 4 can be protected by the second case part 2. In this way, the operation buttons 4 can be prevented from being inadvertently operated when the user carries the handset with him/her. When the second case part 2 is lifted up from the first case part 1, the user can operate the operation buttons 4 while looking at the display 8, talk using the speaker 9 and the microphone 5 or carry out photographing while operating the operation buttons 4.

The use of the clamshell design allows the display 8 to be provided substantially entirely on one surface of the second case part 2, so that the size of the display 8 can be enlarged without degrading the portability of the mobile phone and the visibility can be improved.

The internal radio communication antennas 7 and 10 are provided at the first and second case parts 1 and 2, respectively, so that data transmission between the first and second case parts 1 and 2 can be carried out by internal radio communication using the internal radio communication antennas 7 and 10. For example, image data or audio data obtained in the first case part 1 through the external radio communication antenna 6 may be transmitted to the second case part 2 by internal radio communication using the internal radio communication antennas 7 and 10, so that the display 8 can display the image or the speaker 9 can output an audio sound based on the data. Photo data taken by the imaging device 12 may be transmitted to the first case part 1 from the second case part 2 by internal radio-communication using the internal radio communication antennas 7 and 10, so that the data can externally be output through the external radio communication antenna 6.

In this way, the data transmission between the first and second case parts 1 and 2 does not have to be carried out by wire, so that a flexible circuit board with a large number of pins does not have to be passed through the hinge 3. Therefore, the hinge 3 does not need a complicated structure, and the mounting step is not complicated. Therefore, the cost can be kept from increasing while the mobile phone handset can be compact and thin and have high reliability. In this way, the mobile phone may have a larger screen size and an increased number of functions without degrading its portability.

In the described embodiment, the external radio communication antenna 6 is attached to the first case part 1, while the external radio communication antenna 6 may be attached to the second case part 2.

As shown in FIG. 3, the data transmission between the first and second case parts 1 and 2 is carried out by code division multiple access (CDMA). Herein, for ease of description, assume that an external radio communication unit 20A is connected to the external radio communication antenna 6 of the first case part 1 to carry out radio communication with an external base station and has a mobile phone function, an e-mail transmitting/receiving function, and a data downloading function, and an internal radio receiving unit 20B receives image data or other data from the second case part 2 by internal radio communication. Assume also that the second case part 2 includes three radio transmitting units 30A, 30B, and 30C that individually transmit data from the imaging elements 12a to 12c to the side of the first case part 1.

As shown in FIG. 4, the radio transmitting units 30A to 30C of the second case part 2 each include a mapping unit 101 that receives transmission data from corresponding one of the imaging elements 12a to 12c and forms complex data made of inphase data I and orthogonal data Q that define the amplitude and the relative phase to an orthogonal carrier for digital modulation, and a spreading modulator 102 that multiplies the inphase data I and the orthogonal data Q output from the mapping unit 101 by a spreading code at a rate higher than the data interval to carry out spectrum spreading, a spreading code generator 103 that supplies a spreading code to the spreading modulator 102, a modulator 104 that receives an intermediate frequency band transmission signal having its band spread by frequency spreading output from the spreading modulator 102 and up-converts the transmission signal to a radio frequency band, and a transmitting antenna 105 supplied with the transmission signal output from the modulator 104. Herein, a spreading clock signal and a symbol synchronization signal output from a synchronization signal generator 207 in the internal radio receiving unit 20B in the first case part 1 are input to the spreading code generator 103 through wire communication paths 111 and 112, as will be described, and a spreading code allocated specifically to the spreading clock signal and the symbol synchronization signal is generated and output to the spreading modulator 102.

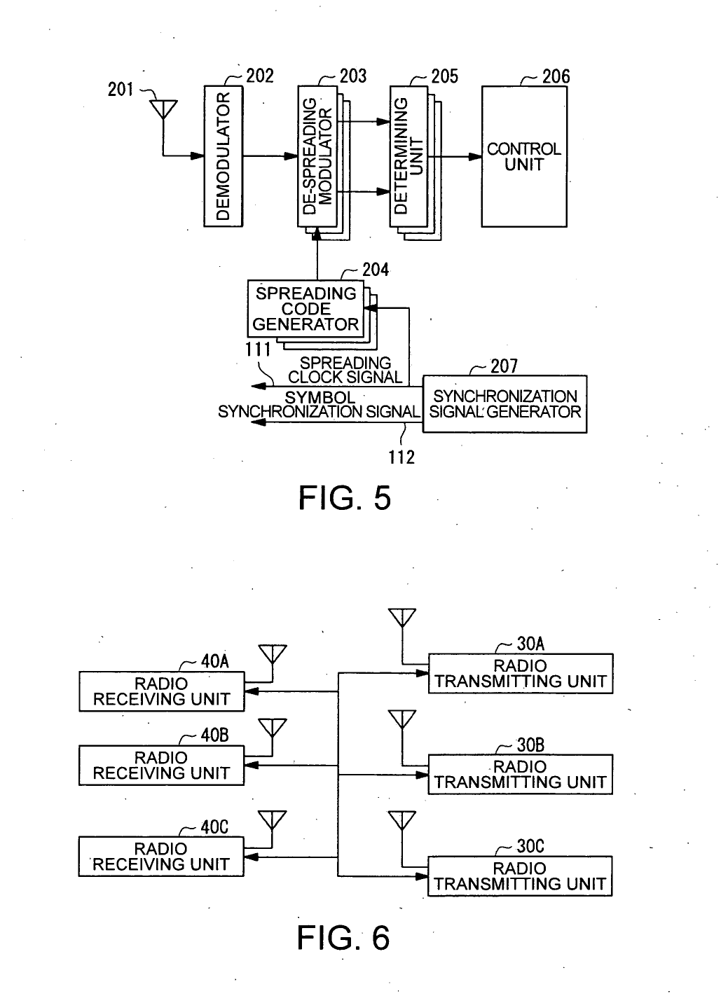

As shown in FIG. 5, the internal radio receiving unit 20B in the first case part 1 includes a demodulator 202 that is provided with a reception signal received at a receiving antenna 201 and down-converts the signal into a base band signal, a plurality of de-spreading units 203 that de-spread spreading codes corresponding to the radio transmitting units 30A to 30C and demodulates the inphase data I and the orthogonal data Q, a plurality of spreading code generators 204 that generate the spreading codes to be supplied individually to the plurality of de-spreading units 203, a plurality of determining units 205 that determine the inphase data I and the orthogonal data demodulated by the de-spreading modulators 204 based on a threshold and output the reception data, and a control unit 206 that is provided with the reception data output from the determining units 205.

The spreading clock signal generated by the synchronization signal generator 207 is input to the spreading code generator 204, and spreading codes corresponding to the radio transmitting units 30A to 30C are generated in response to the spreading clock signal.

Then, the spreading clock signal and the symbol synchronization signal generated by the synchronization signal generator 207 are supplied to the spreading code generators 103 in the radio transmitting units 30A to 30C through the wire communication paths 111 and 112 described above.

Now, the operation of the first embodiment will be described.

Transmission data is formed by the imaging elements 12a to 12c and supplied to the mapping units 101 in the radio transmitting units 30A to 30C, and the mapping units 101 each form complex data made of the inphase data I and the orthogonal data Q that define the amplitude and the relative phase to an orthogonal carrier, and the complex data is supplied to the spreading modulator 102. In the spreading modulator 102, spreading codes specifically allocated to the radio transmitting units 30A to 30C based on the spreading clock signal directly supplied through the wire communication paths 111 and 112 from the synchronization signal generator 207 in the internal radio receiving unit 20B are generated in synchronization with the symbol synchronization signal, and the spreading codes are supplied to the spreading modulators 102. In this way, the inphase data I and the orthogonal data Q are multiplied by the spreading codes to cause spectrum spreading, so that an intermediate frequency band transmission signal having its band spread output from the spreading modulator 102 is up-converted to a radio frequency band by the modulator 104 to which the symbol synchronization signal is input, so that the up-converted signal is radiated from the transmitting antenna 105.

In the internal radio receiving unit 20B, the transmission signals simultaneously transmitted from the radio transmitting units 30A and 30C are received at the receiving antenna 201 and supplied to the demodulator 202, the signals have their frequencies converted to those of base band signals by the demodulator 202, and the base band signals are multiplied by spreading codes set corresponding to the radio transmitting units 30A to 30C at a rate higher than the data interval by the de-spreading modulator 203 and de-spread by the different spreading codes. In this way, the signals are returned to the original narrow band signals, and the signal data is demodulated by threshold determination by the determining unit for supply to the control unit 206.

At the time, the spreading clock signal and the symbol synchronization signal are directly supplied to the radio transmitting units 30A to 30C from the synchronization signal generator 207 in the internal radio receiving unit 20B through the wire communication paths 111 and 112. The timings and phases of the spreading codes can be synchronized at these plurality of radio transmitting units 30A to 30C, so that radio communication is enabled without interference in a common band by code multiplexing while keeping the orthogonality of code division multiple access (CDMA).

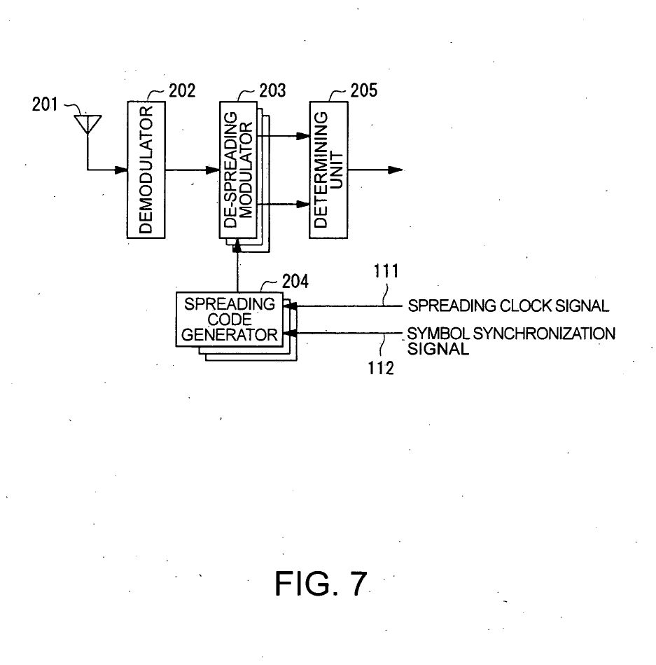

Note that according to the first embodiment, the plurality of radio transmitting units 30A to 30C and the single internal radio receiving unit 20B are used to carry out radio transmission/reception as shown in FIG. 3, while the invention is not limited to the arrangement. When for example a plurality of radio receiving units 40A to 40C are used as shown in FIG. 6, one of the units, for example 40A may have the structure of the internal radio receiving unit as shown in FIG. 5, the other radio receiving units 40B and 40C may directly receive the spreading clock signal and the symbol synchronization signal from the synchronization signal generator 207 through the wire communication paths 111 and 112 and the synchronization signal generator 207 may be omitted as shown in FIG. 7.

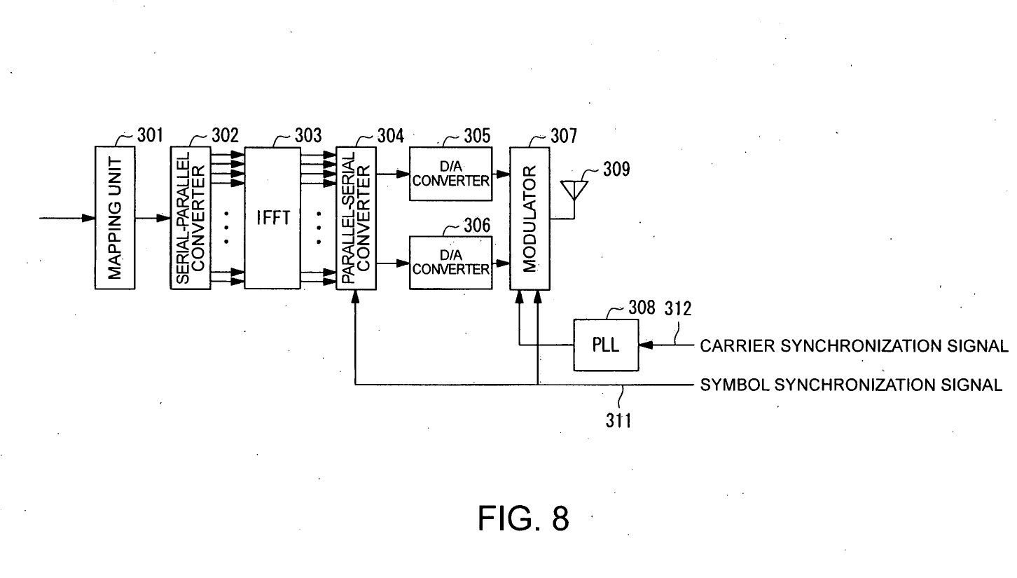

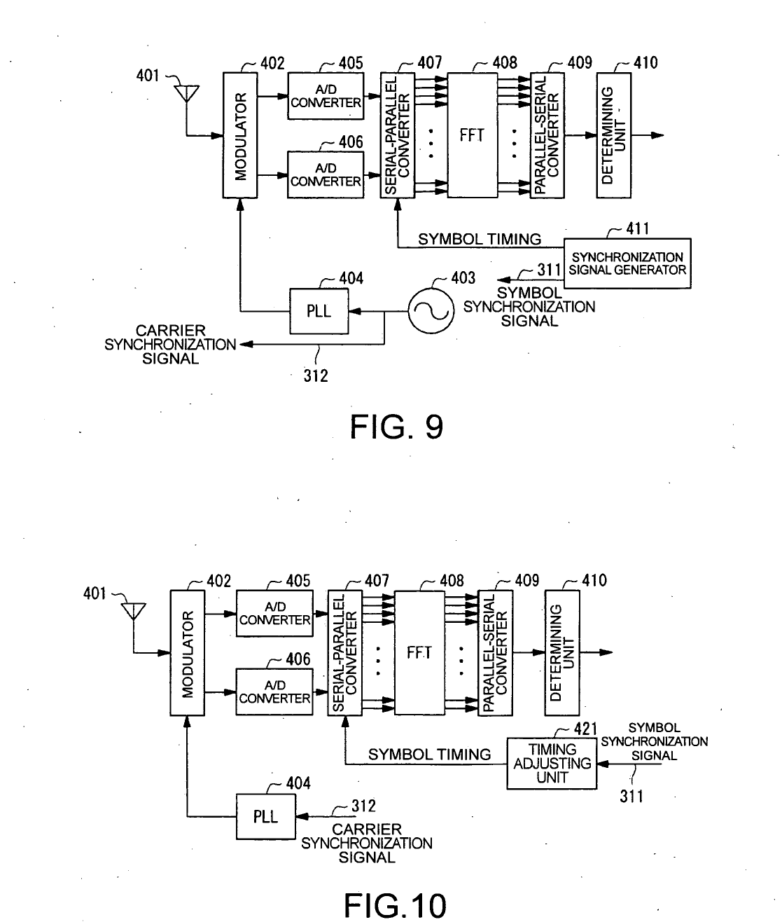

Now, a second embodiment of the invention will be described in conjunction with FIGS. 8 and 9.

According to the second embodiment, data communication between the first and second case parts 1 and 2 is carried out according to orthogonal frequency division multiplexing (OFDM) instead of code division multiple access.

More specifically, according to the second embodiment, as shown in FIG. 8, the radio transmitting units 30A to 30C each include a mapping unit 301 that forms complex data made of inphase data I and orthogonal data Q that define the amplitude and the relative phase to an orthogonal carrier for digital modulation in response to input transmission data, a serial-parallel converter 302 that obtains the complex data output from the mapping unit 301 and converts the complex data into a set of complex data pieces (individually allocated to a plurality of orthogonal carriers) as many as the number of orthogonal carriers for orthogonal frequency division multiplexing (OFDM), an inverse fast Fourier transform (IFFT) unit 303 that is provided with the complex data and outputs a waveform signal obtained by digital modulation based on a complex data piece corresponding to the amplitude and phase of the orthogonal carrier therein, a parallel-serial converter 304 that outputs the complex data output from the inverse fast Fourier transform unit 303 in parallel for each symbol interval on the time base, D/A converters 305 and 306 that obtain the signals on the time base output from the parallel-serial converter 304 and convert the signals into analog signals, a modulator 307 that up-converts the analog signals output from these D/A converters 305 and 306 into signals in a radio frequency band, and a transmitting antenna 309 supplied with transmission signals from the modulator 307.

Herein, the parallel-serial converter 304 and the modulator 307 are supplied with the symbol synchronization signal output from a synchronization signal generator 411 in the internal radio receiving unit 20B that will be described through a wire communication path 311. The modulator 307 is supplied with a timing signal output from a PLL circuit 308 that obtains a carrier synchronization signal oscillated by a local oscillator 403 in the internal radio receiving unit 20B and generates a timing signal locked to a desired frequency, i.e., a frequency estimated on the receiving side based on the input signal.

Meanwhile, the serial-parallel converter 302 can allocate data to the orthogonal carriers for orthogonal frequency division multiplexing (OFDM), and the radio transmitting units 30A to 30C each select an input port so that a signal at a corresponding allocated frequency is produced by the inverse fast Fourier transform unit 303.

As shown in FIG. 9, the internal radio receiving unit 20B includes a receiving antenna 401, a demodulator 402 that demodulates signals on the time base by multiplying an OFDM reception signal received at the receiving antenna 401 individually by an oscillation output produced by locking the carrier synchronization signal oscillated by the local oscillator 403 to a base band signal by the PLL circuit 404 and an output 90° shifted from the output, A/D converters 405 and 406 that convert a demodulated signal from the demodulator 402 into a digital signal, a serial-parallel converter 407 that carries out parallel conversion based on a symbol timing input from the synchronization signal generator 411, and a fast Fourier transform (FFT) unit 408 that subjects parallel signals output from the serial-parallel converter 407 to fast Fourier transform, a parallel-serial converter 409 that converts the fast Fourier transform outputs from the fast Fourier transform unit 408 into a serial signal, and a determining unit 410 that determines the serial signal output from the parallel-serial converter 409 and obtains reception data the same as the original transmission data.

Herein, the synchronization signal generator 411 communicates a symbol synchronization signal to the radio transmitting units 30A to 30B by wire through the wire communication path 311, and delays the symbol synchronization signal for supply to the serial-parallel converter 407 as a symbol timing signal. The carrier synchronization signal generated by the local oscillator 403 is directly supplied to the PLL circuit 308 in each of the radio transmitting units 30A to 30C through the wire communication path 312.

Now, the operation of the second embodiment will be described.

When transmission data to the internal radio receiving unit 20B is formed in the radio transmitting units 30A to 30C, the transmission data is made into complex data by the mapping unit 301, and converted into parallel signals at the serial-parallel converter 302. Then, the signals have their signal waveforms converted into waveforms obtained by digital modulation to the amplitude and phase of the individual orthogonal carriers based on corresponding complex data by the inverse Fourier transform unit 303, and data for each symbol interval on the time base is output in parallel from the inverse Fourier transform unit 303.

The parallel data is converted into a serial signal by the parallel-serial converter 304 in response to the symbol synchronization signal output from the symbol synchronization signal generator 411 in the internal radio receiving unit 20B and the signal on the time base is output. The signal on the time base is converted to an analog value by the D/A converters 305 and 306, and supplied to the modulator 307 to which a carrier signal locked by the PLL circuit 308 based on the symbol synchronization signal and the carrier synchronization signal is supplied.

In the modulator 307, based on the carrier synchronization signal supplied from the PLL circuit 308, the supplied signal is up-converted and has its transmission timing adjusted in response to the symbol synchronization signal, and the transmission signal is output to the transmitting antenna 309.

In the meantime, in the internal radio receiving unit 20B, the reception signal received at the receiving antenna 401 is supplied to the demodulator 402 to which a carrier synchronization signal oscillated by the local oscillator 403 and locked and output by the PLL circuit 404 is supplied, so that the reception signal is multiplied by the carrier synchronization signal and a carrier synchronization signal 90° shifted in phase to demodulate the reception signal. The demodulated signal is converted to a digital signal by A/D converters 405 and 406 for input to the serial-parallel converter 407, so that the signal is converted into parallel signals based on a symbol timing signal applied from the synchronization signal generator 411, the resultant signals are supplied to a fast Fourier transform unit 408 for fast Fourier transform, and the resultant signals are converted into a serial signal at a parallel serial converter 409 for supply to the determining unit 410. In this way, reception data identical to the original transmission data is obtained.

In this way, according to the second embodiment, the symbol synchronization signal and the carrier synchronization signal can directly be transmitted from the radio receiving unit 20B to the plurality of radio transmitting units 30A to 30C through the wire communication paths 311 and 312. The carrier synchronization is achieved as well as the symbol intervals can be synchronized among the plurality of radio transmitting units 30A to 30C, so that communication is enabled without interference in a band allocated to the plurality of radio transmitting units while the orthogonality of the OFDM signal is secured.

According to the second embodiment, when the plurality of radio receiving units 40A to 40C are provided as shown in FIG. 6, one of them, the unit 40A for example may have the same structure as in FIG. 9, and for the other radio receiving units 40B and 40C, a timing adjusting unit 421 that receives and delays the symbol synchronization signal transmitted through the radio communication path 311 from the synchronization signal generator 411 to form a symbol timing signal may be provided while the synchronization signal generator 411 is omitted as shown in FIG. 10. In this case, the symbol synchronization signal and the carrier synchronization signal are shared among the plurality of radio receiving units 40A to 40C. Therefore carrier synchronization can be achieved among the radio receiving units 40A to 40C, and the symbol intervals can be synchronized. Therefore, communication according to orthogonal frequency division multiplexing can be carried out without interference in a band allocated to the radio receiving units 40A to 40C while the orthogonality of the OFDM signal is secured.

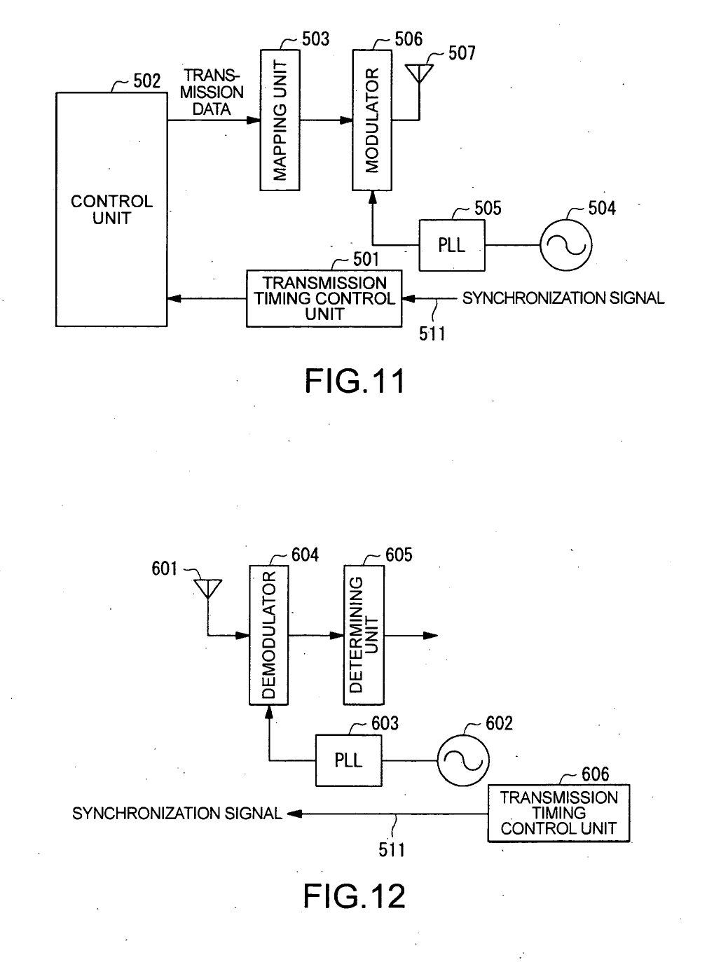

Now, a third embodiment of the invention will be described in conjunction with FIGS. 11 and 12.

According to the third embodiment, data transmission between the plurality of radio transmitting units 30A to 30C and the radio receiving unit 20B is carried out according to time division multiple access (TDMA).

More specifically, as shown in FIG. 11, according to the third embodiment, the plurality of radio transmitting units 30A to 30C each include a transmission timing control unit 501 provided with a synchronization signal from the radio receiving unit 20B through a wire communication path 511 as a wire communication member to produce a corresponding transmission enable signal allocated to each unit based on the input signal, a control unit 502 provided with the transmission enable signal output from the transmission timing control unit 501 to output transmission data input from the displays 8 and 11 and the imaging elements 12a to 12c based on the input signal, a mapping unit 503 that forms complex data made of inphase data I and orthogonal data Q that define the amplitude and the relative phase to an orthogonal carrier for digital modulation of the transmission data output from the control unit 502, a modulator 506 that multiplies the complex data output from the mapping unit 503 by a carrier signal from the PLL circuit 505 that locks to the carrier signal from the local oscillator 504 by the carrier signal from the PLL 505 for up-converting to a radio communication band, and a transmitting antenna 507 supplied with the transmission signal output from the modulator 506.

As shown in FIG. 12, the radio receiving unit 20B includes a receiving antenna 601 that receives a TDMA transmission signal transmitted from the plurality of radio transmitting units 30A to 30C, a demodulator 604 that receives the reception signal received at the receiving antenna 601 and multiplies the reception signal by a carrier signal input from a PLL circuit 603 that locks to a carrier signal oscillated by a local oscillator 602 for down-converting, a determining unit 605 that determines the data of a base band signal demodulated by the demodulator 604, and a transmission timing control unit 606 that generates a synchronization signal and transmits the signal to the radio transmitting units 30A to 30C through the wire communication path 511.

Here, the transmission timing control unit 606 transmits the synchronization signal to the radio transmitting units 30A to 30C through the wire communication path 511. The unit generates a specific transmission start pattern and a transmission timing synchronization signal and transmits these signals as the synchronization signal to the transmission control unit 501 in each of the radio transmitting units 30A to 30C.

According to the third embodiment, when communication is carried out for a certain fixed period using a signal according to TDMA by the plurality of radio communication units 30A to 30C, the radio transmitting units 30A to 30C are notified of the start of the signal in the specified signal start pattern generated by the transmission timing control unit 606 in the radio receiving unit 20B through the wire communication path 511. The radio transmitting units 30A to 30C each transmit with a transmission slot determined in advance. Thereafter, during the transmission, the radio transmitting units 30A to 30C transmit in synchronization in response to a transmission timing synchronization signal from the radio receiving unit 20B. The transmission timing is controlled by the single transmission timing control unit 606, so that transmission signals from the plurality of radio transmitting units 30A to 30C do not overlap, multiplex communication can readily be carried out by TDMA by transmitting the transmission timing signal by wire.

Note that according to the third embodiment, the transmission is carried out at a time according to TDMA, but the invention is not limited to the arrangement. The transmission timing control unit 606 may transmit a polling signal directed to a radio transmitting unit to be permitted to communicate among the radio transmitting units by wire, and each radio transmitting unit that receives the signal determines whether or not the signal is the polling signal directed to itself. Then, if the signal is a transmission request to the unit, the unit may immediately start transmitting data. In this case, the transmission timing control unit 501 in FIG. 11 determines whether or not the synchronization signal is a polling signal to the unit and if the signal is a polling signal directed to itself, the unit may notify the control unit 502 of the result, so that the transmission data starts to be output. The transmission timing control unit 606 in FIG. 12 transmits a pattern specifically allocated to each of the radio transmitting units 30A to 30C as a synchronization signal to the wire communication path 511 and can carry out polling to the radio transmitting units 30A to 30C.

As described in conjunction with FIG. 6, when the plurality of radio receiving units 40A to 40C are provided, one of the radio receiving units, 40A for example, may have a transmission timing control unit 606 and the other radio receiving units 40B and 40C may each start to receive the synchronization signal received through the wire communication path 511 from the transmission timing unit 606 if the signal is a data slot allocated for each of the radio receiving units to be received.

Note that according to the first to third embodiments described above, the radio receiving unit 20B transmits the synchronization signal to the radio transmitting units by wire through the wire communication path, while the invention is not limited to the arrangement. The synchronization signal may be generated by one of the plurality of radio communication units, and sent by wire to the radio transmitting units and the radio receiving unit, and still the same advantages as those according to the first to third embodiments may be provided.

According to the first to third embodiments, the three radio transmitting units 30A to 30C are provided, but the invention is not limited to the arrangement. The invention may be applied to the case where two or more radio transmitting units are provided. The equipment connected to the radio transmitting units 30A to 30C to transmit transmission data may be an arbitrary data transmitting device such as a gyro sensor and a GPS receiver other than the imaging elements 12a to 12c described above.

According to the first to third embodiments, for ease of description, data is transmitted from the side of the second case part to the side of the first case part, but the invention is not limited to the arrangement. The invention may be applied to the case where display data is transmitted from a control unit provided in the first case part 1 to the displays 8 and 12 in the second case part 2 or audio data is transmitted to a speaker 9.

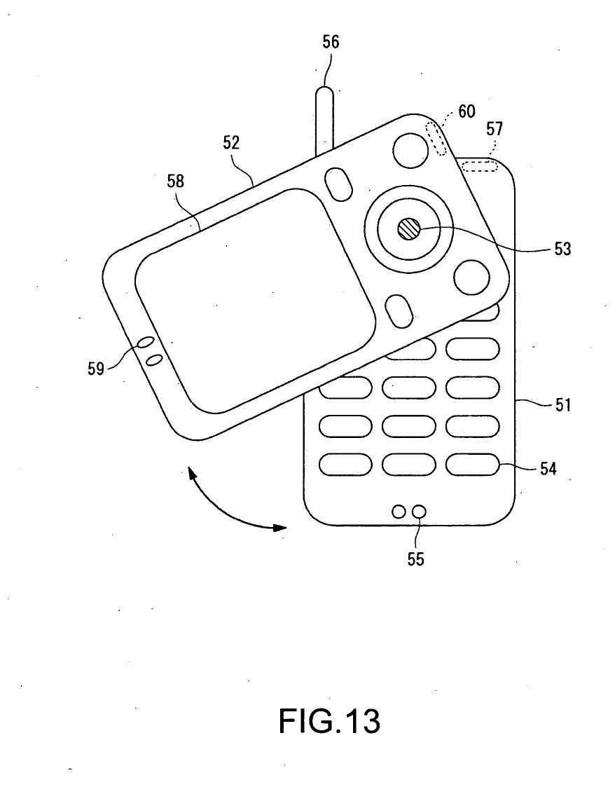

Furthermore, according to the above embodiments, the invention is applied to the clamshell type mobile phone handset, but the invention may be applied to a rotary type mobile phone handset as shown in FIG. 13 other than the clamshell type.

More specifically, in FIG. 13, operation buttons 54 are provided at the surface of a first case part 51, a microphone 55 is provided at the lower end of the first case part 51, and an external radio communication antenna 56 is attached to the upper end of the first case part 51. A display 58 is provided at the surface of a second case part 52, and a speaker 59 is provided at the upper end of the second case part 52. The first and second case parts 51 and 52 are provided with internal radio communication antennas 57 and 60 respectively for the purpose of internal radio communication between the first and second case parts 51 and 52.

The first and second case parts 51 and 52 are coupled through a hinge 53. The second case part 52 may be pivoted horizontally around the hinge 53 to come down on the first case part 51 or to be shifted from the first case part 51. When the second case part 52 is placed on the first case part 51, the operation buttons 54 may be protected by the second case part 52, so that any of the operation buttons 54 may be prevented from being inadvertently pressed as the user carries the handset with him/her. When the second case part 52 is horizontally pivoted and shifted from the first case part 51, the user may operate the operation buttons 54 while looking at the display 58 or talk using the speaker 59 and the microphone 55.

In this case, the internal radio communication antennas 57 and 60 are provided in the first and second case parts 51 and 52, respectively. In this way, data may be transmitted between the first and second case parts 51 and 52 by internal radio communication using the internal radio communication antennas 57 and 60. For example, image data or audio data obtained in the first case part 51 by the external radio communication antenna 56 may be transmitted to the second case part 52 through the internal radio communication antennas 57 and 60 by internal radio communication, so that an image based on the data may be displayed by the display 58 or an audio sound based on the data may be output from the speaker 59.

In this way, it is no longer necessary to pass a flexible printed circuit board with a large number of pins through the hinge 53, and the structure of the hinge 53 may be less complicated, while the mounting step may be less complicated as well. This can restrain the cost increase, and a compact and thinner mobile phone handset with higher reliability can be obtained. The screen size and the number of available functions of the mobile phone may be increased without hampering the portability of the mobile phone.

Furthermore, according to the embodiments, the invention is applied to the mobile phone handset as an electronic device, but the invention may be applied to other types of devices. The invention is applicable for example to any other arbitrary electronic device such as a video camera a PDA (Personal Digital Assistance), and a note type personal computer, an electronic device having first and second case parts coupled by a coupling unit such as a hinge.

Furthermore, according to the described embodiments, one-way communication is carried out from the second case part 2 to the first case part 1 as an example, while the invention may be applied to two-way communication between the first and second case parts 1 and 2. In the above described embodiments, the first and second case parts 1 and 2 are connected through the hinge 3, while the invention is applicable to wireless connection between modules stored in a single case part.

The entire disclosure of Japanese Patent Application No. 2005-87910, filed Mar. 25, 2005 is expressly incorporated by reference herein.

What is claimed is:

1. An electronic device, comprising:
a plurality of radio transmitting units;
at least one radio receiving unit, the plurality of radio transmitting units and the radio receiving unit carrying out radio communication with one another in the device; and
a wire communication member that communicates a synchronization signal among the plurality of radio transmitting units and the radio receiving unit by wire.

2. The electronic device according to claim 1, wherein the plurality of radio transmitting units and the radio receiving unit carry out radio communication by code division multiple access, and a spreading clock signal and a symbol synchronization signal generated by a synchronization signal generator provided in one of the radio transmitting units and the radio receiving unit are transmitted by wire to the rest of the radio transmitting units and/or the radio receiving unit using the wire communication member.

3. The electronic device according to claim 1, wherein the plurality of radio transmitting units and the radio receiving unit carry out radio communication by orthogonal frequency division multiplexing, and a symbol synchronization signal generated by a synchronization signal generator and a carrier synchronization signal oscillated by a local oscillator provided in one of the radio transmitting units and the radio receiving unit are transmitted by wire to the rest of the radio transmitting units and/or the radio receiving unit using the wire communication member.

4. The electronic device according to claim 1, wherein the plurality of radio transmitting units and the radio receiving unit carry out radio communication by time division multiple access, and a synchronization signal generated by a transmission timing control unit provided in one of the radio transmitting units and the radio receiving unit is transmitted by wire to the rest of the radio transmitting units and/or the radio receiving unit using the wire communication member.

5. A radio communication terminal, comprising:
a first case part;
a second case part coupled to the first case part;
a coupling unit that couples the first and second case parts in such a manner that the positional relation between the first and second case parts can be changed,
one of the first and second case parts having a plurality of radio transmitting units, the other having at least one radio receiving unit; and
a wire communication member that communicates a synchronization signal by wire between the plurality of radio transmitting units and the radio receiving unit.

6. The radio communication terminal according to claim 5, wherein the plurality of radio transmitting units and the radio receiving unit carry-out radio communication by code division multiple access, and a spreading clock signal and a symbol synchronization signal generated by a synchronization signal generator provided in one of the radio transmitting units and the radio receiving unit are transmitted by wire to the rest of the radio transmitting units and/or the radio receiving unit using the wire communication member.

7. The radio communication terminal according to claim 5, wherein the plurality of radio transmitting units and the radio receiving unit carry out radio communication by orthogonal frequency division multiplexing, and a symbol synchronization signal generated by a synchronization signal generator and a carrier synchronization signal oscillated by a local oscillator provided in one of the radio transmitting units and the radio receiving unit are transmitted by wire to the rest of the radio transmitting units and/or the radio receiving unit using the wire communication member.

8. The radio communication terminal according to claim 5, wherein the plurality of radio transmitting units and the radio receiving unit carry out radio communication by time division multiple access, and a synchronization signal generated by a transmission timing control unit provided in one of the radio transmitting units and the radio receiving unit is communicated by wire to the rest of the radio transmitting units and/or the radio receiving unit using the wire communication member.
